(19) United States
(12) Patent Application Publication
(10) Pub. No.: US 2014/0066063 A1
(43) Pub. Date: Mar. 6, 2014

(54) HEARTBEAT PERIOD DETERMINATION METHOD AND APPARATUS FOR PUSH SERVICE IN WIRELESS NETWORK

(71) Applicant: Samsung Electronics Co., Ltd., Gyeonggi-do (KR)

(72) Inventor: Heyyoung PARK, Seoul (KR)

(73) Assignee: Samsung Electronics Co., Ltd., Gyeonggi-do (KR)

(21) Appl. No.: 14/014,703

(22) Filed: Aug. 30, 2013

(30) Foreign Application Priority Data
Aug. 30, 2012 (KR) 10-2012-0095859

(51) Int. Cl. H04W 4/12

(52) U.S. Cl. CPC H04W 4/12
USPC 455/435.1

(57) ABSTRACT

A heartbeat period determination method and apparatus of a push service in a wireless network is provided. The heartbeat period determination method for a push service in a terminal of a wireless network includes transmitting a registration request message including terminal information and network information to a registration server, receiving a registration reply message including ping interval information from the registration server, establishing a push channel with the push server, and determining the heartbeat period using the received ping interval information.

### PRIORITY

This application claims priority under 35 U.S.C. §119(a) to a Korean Patent Application filed on Aug. 30, 2012 in the Korean Intellectual Property Office and assigned Serial No. 10-2012-0095859, the entire contents of which are incorporated herein by reference.

### BACKGROUND

1. Field of the Invention

The present invention generally relates to a heartbeat period determination method and apparatus of a push service in a wireless network, and more particularly to a heartbeat period determination method and apparatus that is capable of reducing terminal dependency and unnecessary terminal operations by reflecting the terminal condition and connection state between the terminal and the server.

2. Description of the Related Art

Push technology provided on the wired/wireless Internet and cellular communication network infrastructure aims to deliver certain messages and notifications to a mobile terminal. Push technology has been introduced to mitigate the resource constraint of the mobile terminal. With push technology, a plurality of applications running on a terminal share a single common network connection rather than occupying respective network connection resources and transmit messages or notifications to the applications on a mobile platform so as to overcome the restriction of resource shortage to some extent, and to support various services. Apple Push Notification Service (APNS), Google's Cloud to Device Messaging (C2DM), Barunmo Push Notification System (BPNS), mFluent's Cross Platform Notification Service (MPNS), and Seven's Ping™ are all services using push technology.

Typically, in order to provide the push service, the terminal and the push server have to be logically connected with each other. In order to establish the connection between a terminal or User Equipment (UE) and the push server, User Datagram Protocol/Transmission Control Protocol (UDP/TCP) may be used to exchange keep-alive messages for connection continuity. At this time, the keep-alive message transmission interval depends on the firewall timeout policy and is predetermined according to general practices and standards.

In order to maintain the push channel connectivity, the terminal's long term connection has to be guaranteed. One method for maintaining a long term connection is to transmit a heartbeat packet to the server before the expiration of the firewall timeout so as to extend the timeout length of the channel. However, since the firewall timeout period is set differently depending on the operator network and is not exposed to the public, frequent heartbeat packet transmission impacts the battery consumption of the terminal. Thus, it is very important to find the maximum firewall timeout of the system.

In conventional technologies, various methods have been adopted to overcome the problem of connection termination caused by different firewall timeout policies of distinct network operators. For example, the heartbeat period may be determined based on statistical data or a predetermined rule, or by detecting the firewall timeout values using a heuristic approach. By using such dynamic methods, if a predetermined pin period is invalid, it is necessary to track the firewall timeout value again. Also, certain static methods use a fixed ping interval. That is, the conventional technologies calculate (or preconfigure) an optimal (or constantly guaranteeing) heartbeat period and send the heartbeat message before the expiry of the firewall timeout repeatedly so as to prevent the firewall port from being closed, and thus, maintain the long term connection (or session).

The conventional push service-related keep-alive technologies are focused on finding the optimal ping interval by the host transmitting the Ping Request. Accordingly, these technologies use intra-terminal statistics or rule-based or heuristic methods to estimate the firewall timeout. However, these methods are performed by algorithms inside the terminal platform, and thus are terminal-dependent. This means that the heartbeat period changes according to changes in network conditions and breakup time by distinct firewalls of different network areas.

Furthermore, applying such algorithms in situations where the network environment varies increases the number of timers for estimating the firewall timeouts and the number of processes, resulting in overload of the terminal. In the case of using the fixed ping interval with a static method to avoid terminal overload, it is difficult to dynamically cope with the network situation. Also, the use of a minimum heartbeat period capable of avoiding breakup in all the network environments increases the power consumption.

That is, the conventional technologies are embodied in such a way that the server transmits a specific initial value to the terminal, or the terminal determines an optimal heartbeat period using its internal dynamic algorithm. However, the method of transmitting a specific initial value has a drawback in that the heartbeat period is determined regardless of the terminal-specific environment and surrounding environment, and the terminal's internal algorithm-based optimal value determination method has a drawback in that all the terminals execute the algorithm to unnecessarily collect the network condition and information in spite of common features or patterns.

### SUMMARY

Accordingly, an aspect of the present invention provides a heartbeat period determination method and apparatus that is capable of reducing terminal dependency and unnecessary terminal operations by reflecting the terminal condition and connection state between the terminal and the server.

In accordance with an aspect of the present invention, a heartbeat period determination method for a push service in a terminal of a wireless network is provided. The method includes transmitting a registration request message including terminal information and network information to a registration server, receiving a registration reply message including ping interval information from the registration server, establishing a push channel with the push server, and determining the heartbeat period using the received ping interval information.

In accordance with another aspect of the present disclosure, a heartbeat period determination method for a push service in a registration server of a wireless network is provided. The method includes receiving a registration request message including terminal information and network information from a terminal, generating ping interval information based on the terminal information and the network information, and transmitting the ping interval information to the terminal.

### BRIEF DESCRIPTION OF THE DRAWINGS

The features and advantages of the present invention will become more apparent from the following detailed description viewed in conjunction with the accompanying drawings, in which:

FIG. 1 is a diagram illustrating the push service architecture of a wireless network to which the present invention is applied;

FIG. 2 is a block diagram illustrating the architecture of the system operating without the push service;

FIG. 3 is a block diagram illustrating the architecture of the system operating with the push service;

FIG. 4 is a block diagram illustrating a mechanism of transmitting device information from the terminal to the server through a push channel according to an embodiment of the present invention;

FIG. 5 illustrates a terminal log connection protocol according to an embodiment of the present invention;

FIG. 6 illustrates a table of log statistics transmitted from the push server to the terminal according to an embodiment of the present invention;

FIG. 7 illustrates a table listing the network-related supplementary information of the terminal log according to an embodiment of the present invention;

FIG. 8 is a diagram illustrating a mechanism of transmitting a heartbeat packet from the terminal to the server according to an embodiment of the present invention;

FIG. 9 is a diagram illustrating the procedure of the terminal to collect data for the device registration request and send the collected data to the registration server according to an embodiment of the present invention;

FIG. 10 is a diagram illustrating the procedure of the terminal to register device information with the registration server according to an embodiment of the present invention;

FIG. 11 is a diagram illustrating the procedure of establishing and maintaining a push channel between the terminal and the push server according to an embodiment of the present invention;

FIG. 12 is a diagram illustrating operations at the server side in the case where the terminal is connected to a mobile network according to an embodiment of the present invention; and

FIG. 13 is a diagram illustrating operations at the server side in the case where the terminal is not connected to the mobile network according to an embodiment of the present invention.

### DETAILED DESCRIPTION OF EMBODIMENTS OF THE PRESENT INVENTION

Embodiments of the present invention are described in detail with reference to the accompanying drawings. The same reference numbers are used throughout the drawings to refer to the same or like parts. Detailed description of well-known functions and structures incorporated herein may be omitted to avoid obscuring the subject matter of the present invention.

In the following description, the term ‘heartbeat’ denotes a message transmitted by a terminal periodically or non-periodically for maintaining connection to a server.

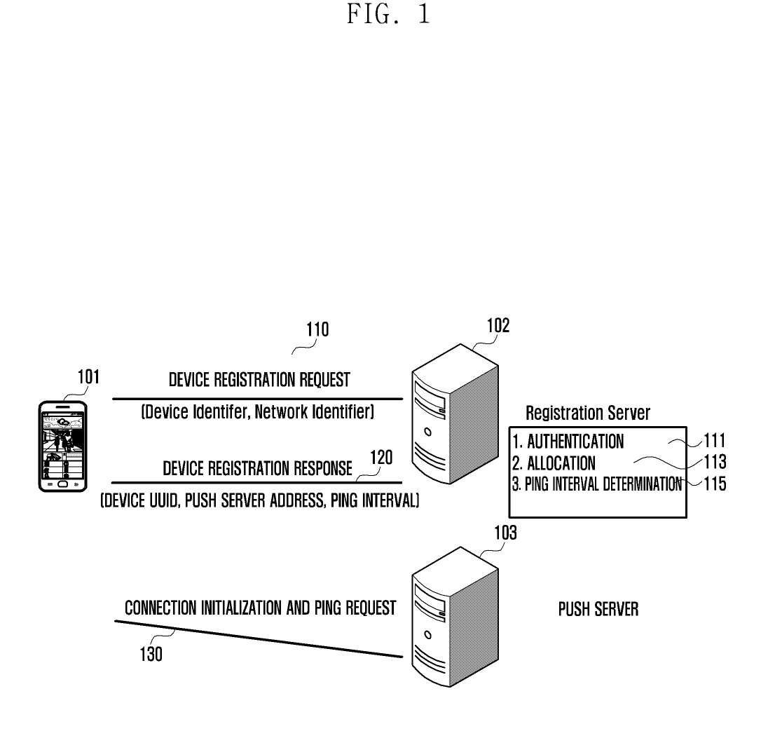

FIG. 1 is a diagram illustrating the push service architecture of a wireless network to which the present invention is applied. As shown in FIG. 1, the wireless network includes a terminal 101, a registration server 102, and a push server 103.

The terminal 101 sends the registration server 102 a device registration request message at operation 110. The device registration request message is a message for the terminal 101 to request registering device information of the terminal 101 for use of the push server 103. The device registration request message may include the device information for identifying the terminal 101 and network information indicating the network condition. The device information may include a device identifier in any of various information formats. The network information may include a network identifier in any of various information formats.

If the device registration message is received, the registration server 102 performs an authentication procedure on the terminal 101 at operation 111. If the terminal is authenticated, the registration server 102 allocates an optimal push server 103 to the terminal 101 according to the characteristics of the terminal and network condition at operation 113. At this time, the registration server 102 allocates the optimal push server 103 based on the device information and network information included in the device registration request message. The registration server 102 determines the ping interval of the terminal 101 at operation 115. The terminal sends a ping message to the corresponding push server 103 statically according to the determined ping interval.

The registration server 102 determines the ping interval optimized to the terminal based on the device information and network information provided by the terminal 101. In order to determine the ping interval, the registration server 102 may generate a ping interval table and a ping interval rule to determine the ping interval.

Next, the registration server 102 sends the terminal 101 a device registration reply message at operation 120. The device registration reply message may include a Device Universally Unique Identifier (UUID), a push server address, and a ping interval.

The terminal 101 initializes the connection with the push server 103 using the information included in the device registration response message received at operation 120 and sends a ping request message to the push server 103 at operation 130. That is, the terminal 101 connects to the push server 103 using the push server address included in the device registration reply message and requests for ping according to the ping interval included in the device registration reply message. The connection initialization of the push server 103 is the process of establishing a single push channel between the terminal 101 and the push server 103 and, after the connection initialization, the terminal 101 transmits the heartbeat packet at the periodic ping interval in order to maintain the keep-alive connection of the push channel. That is, the terminal 101 transmits the heartbeat packet to the push server 103 periodically on the push channel.

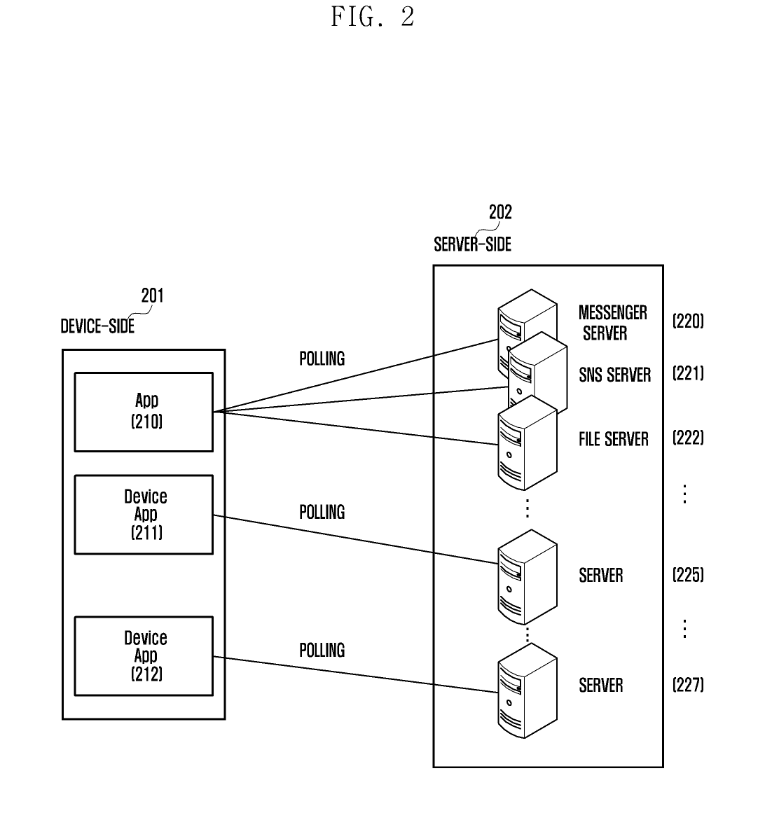

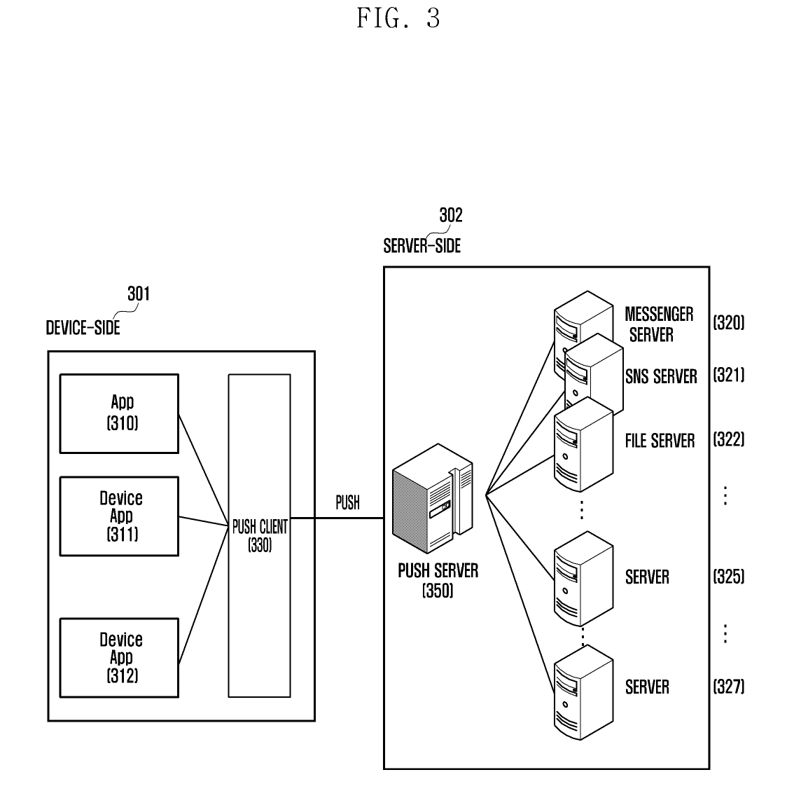

A brief description will now be made of the necessity of the push channel. In order to describe the necessity of the push channel, FIGS. 2 and 3 show the difference between the systems operating with and without push service.

FIG. 2 is a block diagram illustrating the architecture of the system operating without the push service.

As shown in FIG. 2, in the system operating without any push service, the applications 210, 211, and 212 running on the terminal side 201 perform polling to the individual servers 220, 221, 222, . . . , 225, . . . , 227 of the server side 202 respectively. When the individual applications 210, 211, and 212 are polling, the battery consumption of the terminal side 201 and the network traffic between the terminal side 201 and server side 202 increase significantly.

FIG. 3 is a block diagram illustrating the architecture of the system operating with the push service.

As shown in FIG. 3, in the system operating with the push service, the applications 310, 311, and 312 running on the terminal side 301 receive push messages from the push server 350 via a push client 330. At this time, the push server 350 is connected to the individual servers 320, 321, 322, . . . , 325, . . . , 327. In this way, if the terminal side 301 connects to the server side 302 through one channel via the push client 330, and the push server 350 and sends the heartbeat packet to the push server 350 to maintain the corresponding channel, it is possible to minimize both the traffic between the terminal side 301 and the server side 302 and the battery consumption of the terminal side 301.

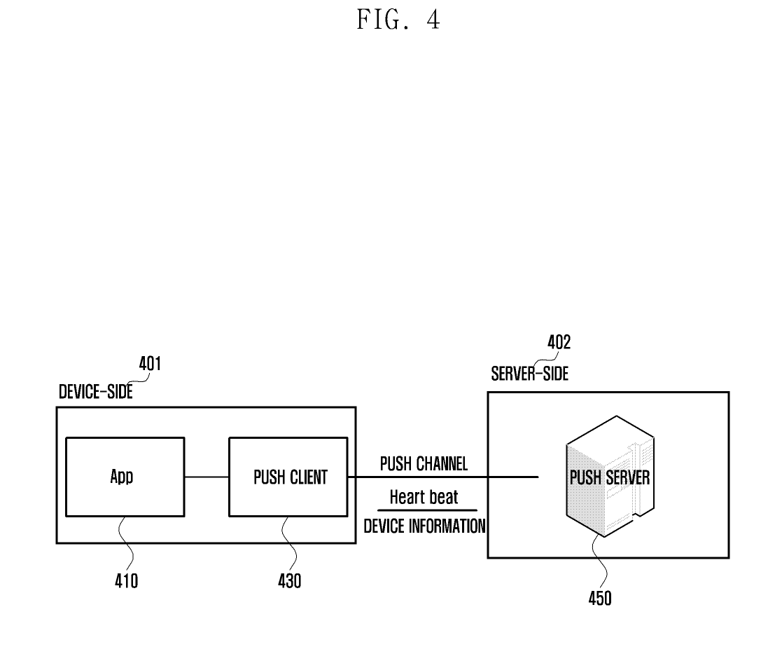

FIG. 4 is a block diagram illustrating a mechanism of transmitting device information from the terminal to the server through a push channel according to an embodiment of the present invention.

As shown in FIG. 4, the terminal 401 transmits the heartbeat packet to maintain the push channel with the push server 450 of the server side 402. At this time, the terminal 401 may transmit supplementary device information on the terminal 401 to the push server 450 over the push channel by means of the push client 430. Here, the supplementary device information denotes all meaningful information provided by the terminal 401 with the exception of the heartbeat. That is, the terminal 401 may transmit data with or without the heartbeat packet on the push channel. The supplementary device information may include device profile information such as Operating System (OS), manufacturer, model, and time information; device location information such as MNC, MCC, GeoIP, and GPS coordinates; device network information such as network state information, wifi/2G/3G/LTE capability, and roaming capability, and device usage information such as usage pattern information.

The supplementary information on the terminal 401 which has been transmitted through the push channel may be used for determining, at the push server 450, the terminal state and network state.

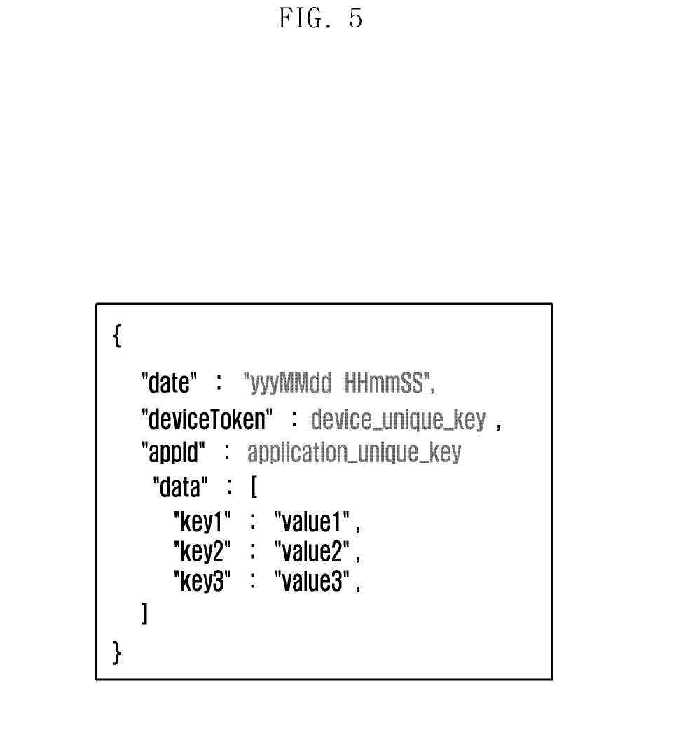

FIG. 5 illustrates a terminal log connection protocol according to an embodiment of the present invention.

As described with reference to FIG. 1, the device registration request message may include the device information on the terminal 101 for use in identifying the terminal and the network information indicating the network status. Here, the device information and the network information may be transmitted in the form of a log data format generated by a log collection protocol of the terminal 101 as shown in FIG. 5. After establishing the push channel, the terminal transmits the terminal log to the server through the push channel or another channel.

According to the protocol of FIG. 5, the terminal may log at least the following information. In FIG. 5, “date” denotes the time when the log is collected. “deviceToken” denotes the terminal identity key information, e.g. IMEI and Device_Serial_Number. “appID” denotes application identity key information, e.g. address book, gallery, calendar, and kakao talk IDs. “data” denotes supplementary information capable of being collected by the terminal, e.g. terminal profile, location information, network information, and usage information.

The protocol depicted in FIG. 5 is just an example utilized in the present invention and may be variously defined to collect various information.

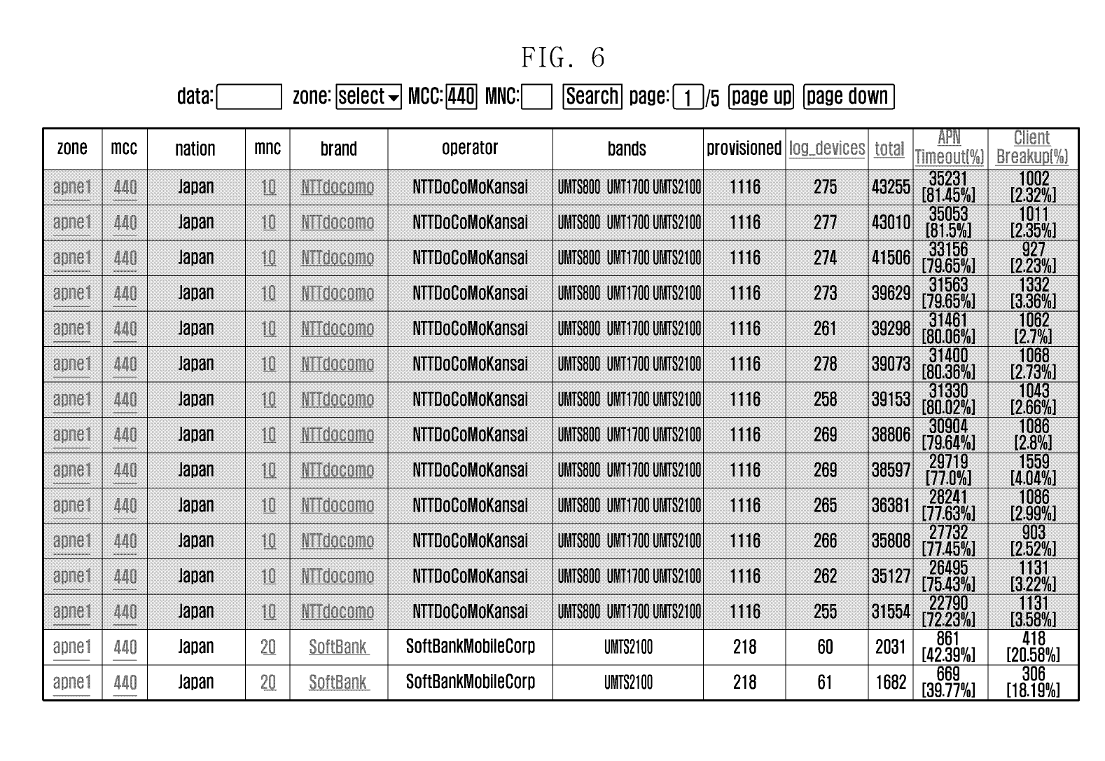

FIG. 6 illustrates a table of log statistics transmitted from the push server to the terminal according to an embodiment of the present invention.

The log recorded using the protocol as depicted in FIG. 5 is transmitted to the push server. The push server stores the data collected from the terminal in the form of a table as shown in FIG. 6 for use in analysis and statistics procedures. The push server performs analysis and statistical processes on the received data to check the status of the terminal's currently connected network and timeout status of APN and extracts average heartbeat period (ping_avg), heartbeat period change value (ping_inc) and maximum firewall time output value (ping_max) per operator network.

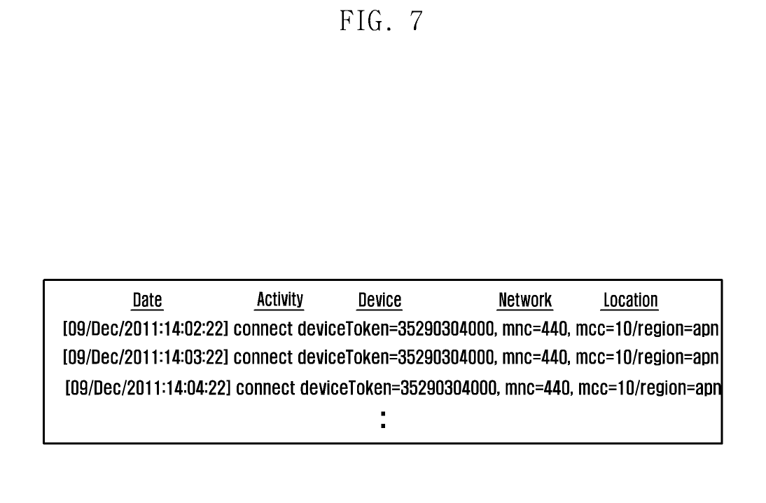

In more detail, the push server sorts the logs transmitted by the terminals per terminal, per network, and per time. FIG. 7 shows network-related supplementary information.

FIG. 7 illustrates a table listing the network-related supplementary information of the terminal log according to an embodiment of the present invention.

Referring to FIG. 7, the network related information includes log date, terminal activity, terminal token, MNC, and location information.

Afterward, the push server calculates connection reestablishment time deviations of the terminals per network. At this time, the time deviations may be calculated based on a predetermined threshold. Here, the threshold is described in the procedure of calculating an average heartbeat period (ping_avg).

The highest value of the time deviation value frequency over the average heartbeat period (ping_avg) is likely to be the maximum timeout value (Max Timeout). Accordingly, this may be configured as the maximum ping (ping_max). The highest value of the time deviation frequency below the average heartbeat period (ping_avg) indicates the case of terminal's frequent breakup, and this may be configured as the minimum ping (ping_min). The push server may determine the maximum ping (ping_max) and minimum ping (ping_min) values per network by repeating the calculating process while changing a specific threshold value (here, average heartbeat period (ping_avg)).

The average heartbeat period (ping_avg), heartbeat period change value (ping_inc), maximum ping (ping_max), and minimum ping (ping_min) calculated in that way are transmitted to the terminal in the device registration replay message or push transmission message.

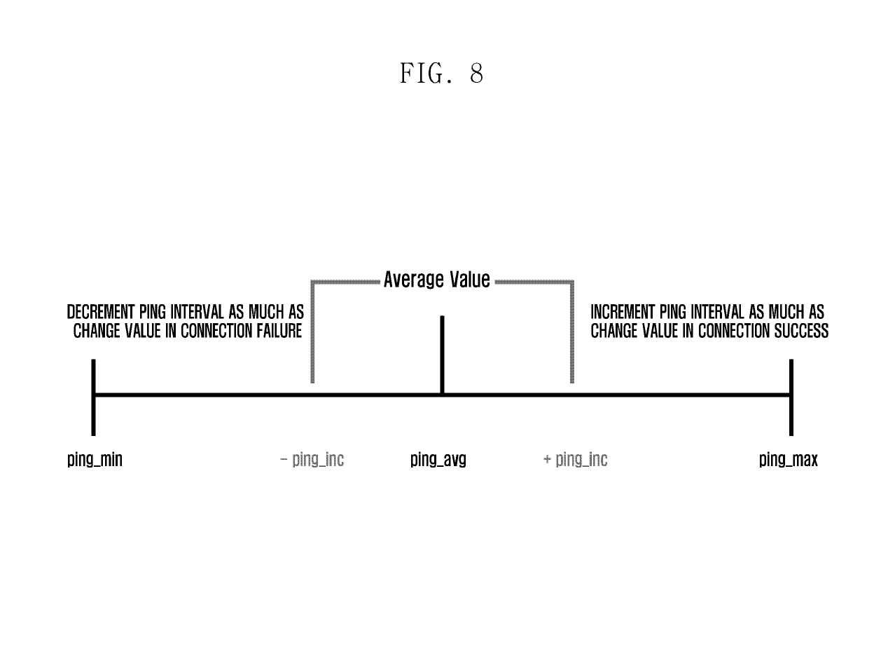

The terminal may transmit the heartbeat period using the information included in the received device registration reply message, and this process is described with reference to FIG. 8.

FIG. 8 is a diagram illustrating a mechanism of transmitting a heartbeat packet from the terminal to the server according to an embodiment of the present invention.

The protocol between the terminal and the server may be defined with following parameters.

ping_avg: operator's average ping interval (minute)

ping_min: minimum ping interval (minute)

ping_max: maximum ping interval (minute)

ping_inc: change value (minute)

The protocol defined with the above parameters is only an example and may be defined differently depending on the situation.

A description will now be made of the procedure of the terminal's heartbeat transmission using the above protocol with reference to FIG. 8. After provisioning, the terminal tries to ping at the heartbeat interval of ping_avg. In the case where the provisioning is caused by an error, if the ping_avg changes and if a new operator's average ping interval (hereinafter, referred to as new_avg) is less than the old ping interval (ping_avg), the terminal retries the ping with ping_avg and, otherwise if new_avg is greater than ping_avg, with new_avg.

If the ping tried with ping_avg is successful, the terminal tries to ping with a changed heartbeat period of ping_avg+ping_inc. At this time, if the ping is successful, the terminal also retries to ping with the heartbeat period incremented by as much as ping_inc. That is, the terminal tries to ping with the heartbeat period of ping_avg+ping_inc+ping_inc. If the ping tried with the heartbeat period of ping_avg+ping_inc fails, the terminal sets the heartbeat period to ping_avg.

If the ping tried with ping_avg fails, the terminal tries to ping with the heartbeat period of ping_average−ping_inc. If the ping fails again with the new heartbeat period, the terminal retries to ping with the heartbeat period of ping_avg−ping_inc−ping_inc. If the ping tried with the heartbeat period of ping_avg−ping_inc is successful, the terminal sets the heartbeat period to ping_avg−ping_inc.

That is, the terminal acquires four values of ping_avg, ping_min, ping_max, and ping_inc with the protocol defined between the terminal and the push server. The terminal sends the push server the heartbeat at the interval of ping_avg using the four values and, if the push channel is maintained, transmits the heartbeat with the ping_avg incremented by as much as ping_inc and, otherwise if the push channel is not connected, with the ping_avg decremented by as much as ping_inc. At this time, the heartbeat period has to be maintained between ping_max and ping_min. Accordingly, if the current heartbeat period is ping_max or if the current heartbeat period+ping_inc is greater than ping_max, the heartbeat period is set to ping_max. If the current period is ping_inc or if current heartbeat period+ping_inc is less than ping_min, the heartbeat period is set to ping_inc.

A description will now be made of the terminal-driving method in more detail. Suppose that the terminal receives the information “ping_avg=10&ping_min=1&ping_inc=4&ping_max=24” from the push server.

At this time, since ping_avg is 10, the heartbeat is transmitted initially at an interval of 10 minutes and, if the connection is maintained, the heartbeat period increments by 4 (i.e. 14, 18, 22, e . . . ) by applying ping_inc=4. However, since ping_max is 24, the heartbeat period increment is limited to 24. If the connection is not maintained, the heartbeat period is decremented by 4 minutes (e.g. 6 and 2) by applying ping_inc=4. However, since ping_min is 1, the heartbeat period decrement is limited to 1 minute.

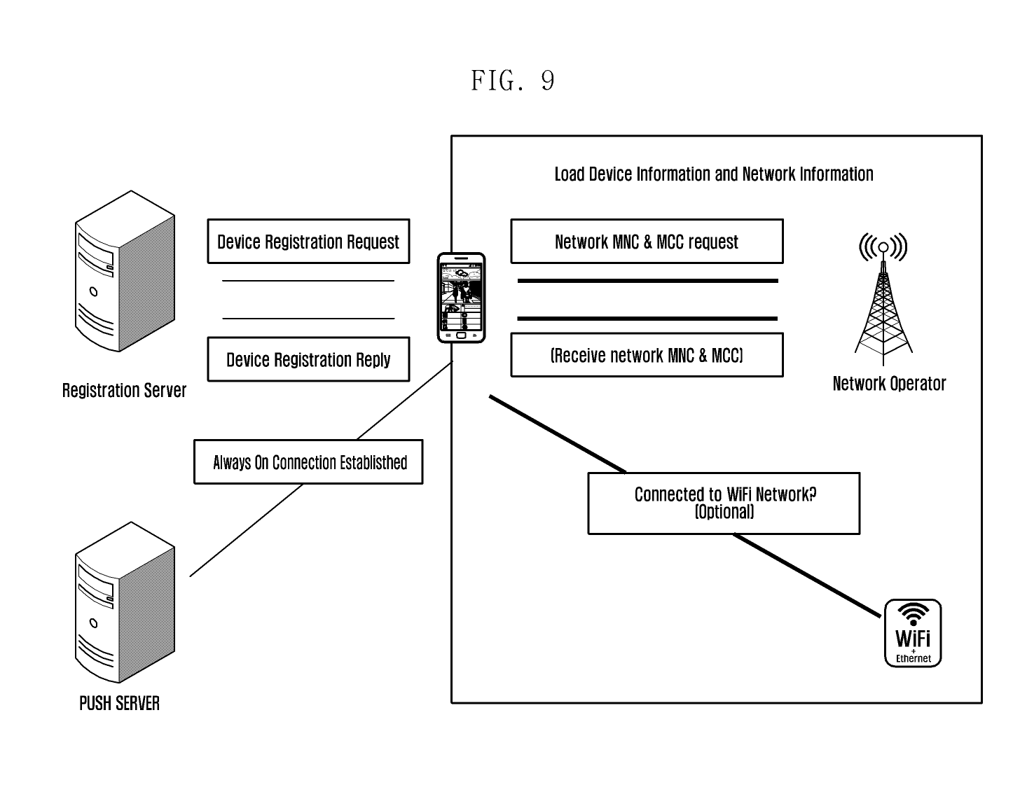

FIGS. 9 to 11 are diagrams illustrating terminal operations according to embodiments of the present disclosure.

FIG. 9 is a diagram illustrating the procedure of the terminal to collect data for the device registration request and send the collected data to the registration server according to an embodiment of the present invention.

After establishing a connection with the network, the terminal receives MCC and MNC as the network identifier from the network. In the case of using a Subscriber Identity Module (SIM) card, the terminal may acquire MCC and MNC from the SIM card. In the case of supporting Wi-Fi, the terminal may acquire information on Wi-Fi connectivity.

Afterward, the terminal may transmit the following information to the registration server.
Device Model Name: device model
Device Id: device identifier such as IMEI and MAC Address
Device Type: device type such as TV, PC, mobile phone
Network MCC & MNC: MCC and MNC when using mobile network
SIM MCC & MNC: MCC and MNC from SIM card when SIM card is used
WiFi Connected (Optional): set to true or false depending on whether the device is Wi-Fi-connected

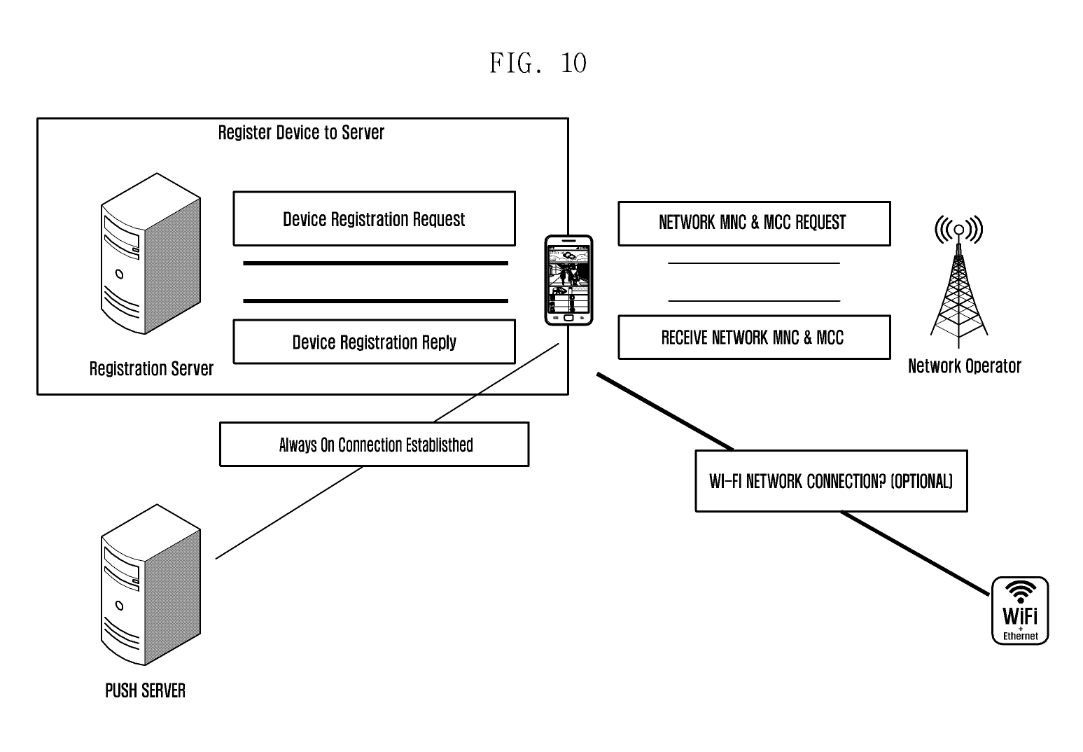

FIG. 10 is a diagram illustrating the procedure of the terminal to register device information with the registration server according to an embodiment of the present invention.

The registration server first receives a device registration request message from the terminal. Next, the registration server sends the terminal a device registration reply message including the following information.
DeviceToken: push device identifier required for connection establishment with the push server.
Push Server Address: push server address to which the device connects for receiving push service
Ping Interval: interval at which the terminal transmits ping request

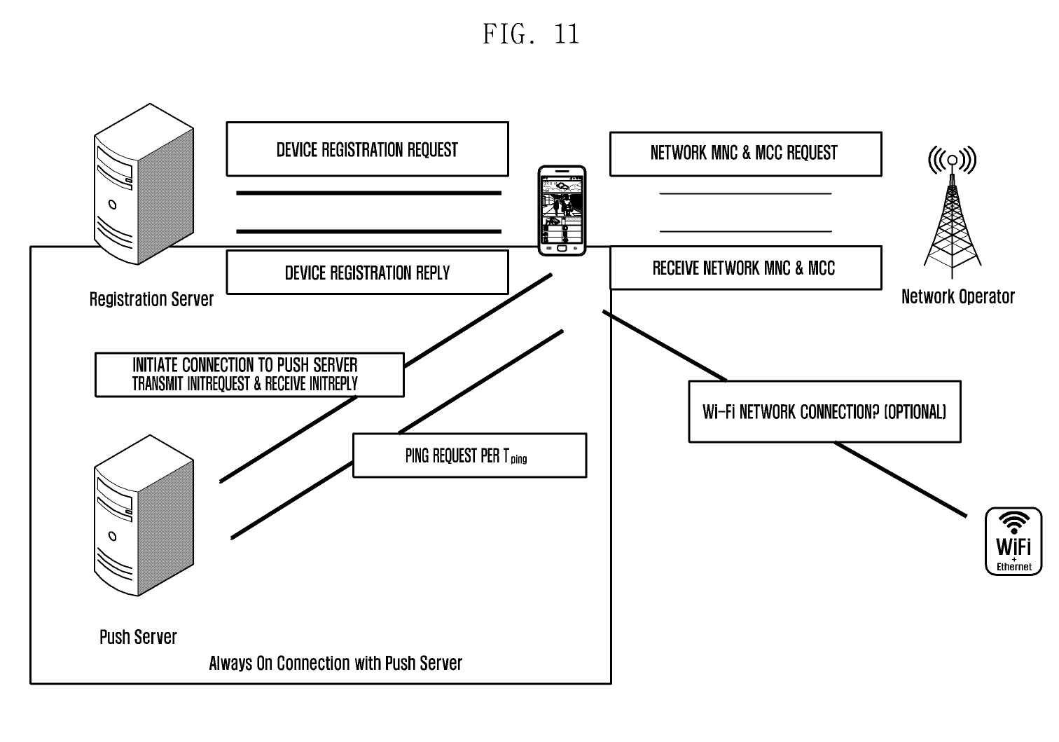

FIG. 11 is a diagram illustrating the procedure of establishing and maintaining a push channel between the terminal and the push server according to an embodiment of the present invention.

The terminal first connects to the push server address received form the registration server and transmits the initialization request (InitRequest) message including DeviceToken information received from the registration server. If the connection to the push server is successful, the terminal transmits the ping request to the push server at the ping interval informed by the registration server. At this time, the terminal may determine the heartbeat period using ping_avg and ping_inc between ping_max and ping_min as described above.

In the above procedure, the device registration process is performed when the terminal attempts to use the push client initially. However, the device registration procedure may also be performed in the following cases:
when the connection between the terminal and the push server fails over a predetermined number of times (consecutive and non-consecutive failures)
when a message requesting re-registration is received from the push server
when the DeviceToken received from the registration server is invalid (e.g. when DeviceToken is deleted)

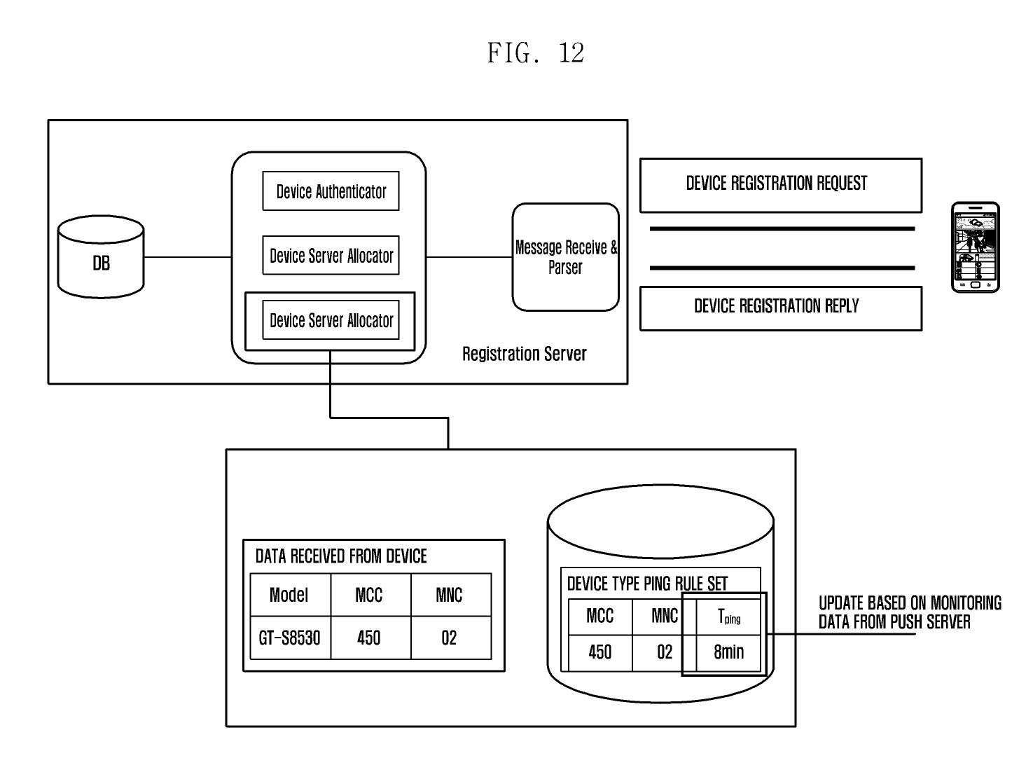

FIG. 12 is a diagram illustrating the operations at the server side in the case where the terminal is connected to a mobile network according to an embodiment of the present invention.

The registration server first checks whether the data received from the terminal includes MCC and MNC. If the MCC and MNC are included, the registration server transmits the ping interval predetermined in the database (DB) according to the MCC and MNC received from the terminal. The ping interval is configured to be closest to the firewall breakup time of the mobile network after performing a field test, or monitoring at the push server, the connection with the terminal.

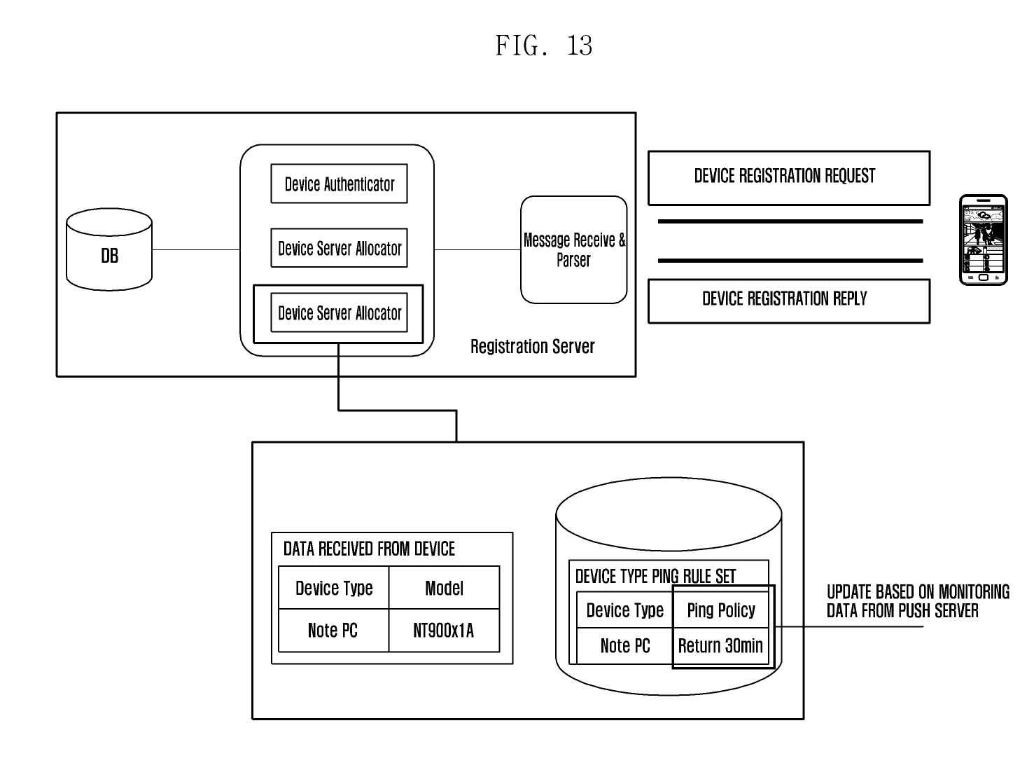

FIG. 13 is a diagram illustrating the operations at the server side in the case where the terminal is not connected to the mobile network according to an embodiment of the present invention.

In the case where it does not use the mobile network, the terminal determines the ping interval according to the terminal characteristics and the push server's connection management logic. The registration server may have a different ping allocation rule depending on the DeviceType information received from the terminal. Referring to FIG. 13, the rule for NotePC may be defined to have the ping interval of 30 minutes.

The ping interval of the terminal may be determined by the firewall breakup time of the distinct operators' networks. If there is no data transmission for predetermined time duration to secure resourceS on the radio network, the firewall breakup time denotes the time of breaking the connection of the terminal.

The ping interval to be informed to the terminal is determined according to the following method.

The server measures and applies the firewall breakup time through a field test. Afterward, the server receives the firewall breakup time from the operator, monitors the connection breakup time of each terminal, and calculates and applies the ping interval.

As described above, the heartbeat period determination method and apparatus of the present disclosure is capable of reducing the terminal dependency and unnecessary operations in the terminal in determining the ping interval of the ping messaging as a method of maintaining the long term connection. That is, the terminal calculates the ping interval according to an internal algorithm or using a ping interval predetermined or received from the server, thereby reducing the power consumption and operation processes and determining the ping interval optimized to the network condition.

Also, the heartbeat period determination method and apparatus of the present disclosure is capable of applying the ping interval dynamically depending on the condition of the network, thereby reducing unnecessary ping message transmissions of the terminal and network overload.

Although embodiments of the invention have been described using specific terms, the specification and drawings are to be regarded in an illustrative rather than a restrictive sense in order to help understand the present invention. It is obvious to those skilled in the art that various modifications and changes can be made thereto without departing from the broader spirit and scope of the invention.

What is claimed is:

1. A heartbeat period determination method for a push service in a terminal of a wireless network, the method comprising:
transmitting a registration request message including terminal information and network information to a registration server;
receiving a registration reply message including ping interval information from the registration server;
establishing a push channel with the push server; and
determining the heartbeat period using the received ping interval information.

2. A heartbeat period determination method for a push service in a registration server of a wireless network, the method comprising:
receiving a registration request message including terminal information and network information from a terminal;
generating ping interval information based on the terminal information and the network information; and
transmitting the ping interval information to the terminal.
